(19) United States
(12) Patent Application Publication
(10) Pub. No.: US 2013/0093668 A1
(43) Pub. Date: Apr. 18, 2013

(54) METHODS AND APPARATUS FOR TRANSMITTING/RECEIVING CALLIGRAPHED WRITING MESSAGE

(71) Applicant: Samsung Electronics Co., Ltd., Gyeonggi-do (KR)

(72) Inventors: Sang-Ho KIM, Gyeonggi-do (KR); Youxin Chen, Beijing (CN); Do-Hyeon Kim, Gyeonggi-do (KR); Jung-Rim Kim, Gyeonggi-do (KR); Jeong-Wan Park, Seoul (KR); Won-Suk Chang, Gyeonggi-do (KR); Seong-Taek Hwang, Gyeonggi-do (KR)

(73) Assignee: Samsung Electronics Co., Ltd., Gyeonggi-do (KR)

(21) Appl. No.: 13/650,917

(22) Filed: Oct. 12, 2012

(30) Foreign Application Priority Data
Oct. 12, 2011 (KR) 10-2011-0104320
Oct. 30, 2011 (KR) 10-2011-0127346

(51) Int. Cl. H04W 4/12; G06F 3/033

(52) U.S. Cl. CPC H04W 4/12; G06F 3/033
USPC 345/156; 455/466

(57) ABSTRACT

Methods and apparatus are provided for transmitting and receiving a calligraphed writing message. Writing data is receiving as input at a transmitting apparatus. The writing data is sampled to generate character frame data having a plurality of point data. Calligraphy control point data is generated using the character frame data. The calligraphed writing message including the calligraphy control point data is generated and transmitted to a receiving apparatus. A calligraphy outline is generated at the receiving apparatus for generation of a calligraphed writing image using the calligraphy control point data from the calligraphed writing message. Graphic processing is performed on the calligraphy outline. The calligraphed writing image is generated and displayed.

### PRIORITY

This application claims priority under 35 U.S.C. §119(a) to a Korean Patent Applications filed in the Korean Intellectual Property Office on Oct. 12, 2011 and Nov. 30, 2011, and assigned Serial Nos. 10-2011-0104320 and 10-2011-0127346, respectively, the contents of which are incorporated herein by reference.

### BACKGROUND OF THE INVENTION

1. Field of the Invention

The present invention relates to generally to an apparatus and a method for transmitting and receiving a message, and more particularly, to an apparatus and a method for transmitting and receiving a calligraphed writing message.

2. Description of the Related Art

When using a short message or messenger service on a smart phone, it is possible to input writing on a touch screen of the smart phone using a pen or a finger, to create an image from the input writing, and then to transmit the imaged writing to another party.

When inputting writing, a text message may be used for direct input by the user. When the text message is transmitted to the other party, user friendliness may be increased because the user directly transmits his/her own writing to the other party.

However, it is difficult for a user to transmit an accurate and calligraphed writing image to the other party since a surface of a touch screen is generally slippery and a feeling provided to the user while inputting writing on the touch screen is uncomfortable.

Further, when a writing image of a user is directly transmitted to the other party, a data capacity is large, thereby increasing a communication fee burden of the user. Accordingly, when a writing image is transmitted in an online server, such as, for example, a real-time message service or a chatting service, it may be inconvenient for a user due to an excessive network upload time.

### SUMMARY OF THE INVENTION

The present invention has been made to address at least the above problems and/or disadvantages and to provide at least the advantages described below. Accordingly, an aspect of the present invention provides an apparatus and a method for transmitting and receiving a calligraphed writing message, in which writing data input through a touch screen is converted into calligraphed writing data and the converted writing data is transmitted to another party.

In accordance with an aspect of the present invention, an apparatus is provided for transmitting a calligraphed writing message. The apparatus includes an input unit for receiving writing data. The apparatus also includes a sampling unit for sampling the writing data to generate character frame data. The character frame data includes a plurality of point data. The apparatus additionally includes a calligraphy unit for generating calligraphy control point data using the character frame data. The calligraphy control point data is used to generate a calligraphed writing image. The apparatus further includes a controller for controlling the sampling unit to generate the character frame data when the writing data is received through the input unit, for controlling the calligraphy unit to generate the calligraphy control point data using the character frame data, for generating the calligraphed writing message including the calligraphy control point data, and for transmitting the calligraphed writing message to a receiving apparatus.

In accordance with another aspect of the present invention, an apparatus is provided for receiving a calligraphed writing message. The apparatus includes a calligraphy unit for generating a calligraphy outline for generation of a calligraphed writing image. The apparatus also includes a graphic processor for performing graphic processing. The apparatus further includes a controller for controlling the calligraphy unit to generate the calligraphy outline using calligraphy control point data when the calligraphed writing message including the calligraphy control point data is received from a transmitting apparatus, controlling the graphic processor to perform the graphic processing on the calligraphy outline, generating the calligraphed writing image, and displaying the calligraphed writing image.

In accordance with another aspect of the present invention, a method is provided for transmitting a calligraphed writing message in a transmitting apparatus. Writing data is sampled to generate character frame data, when the writing data is input. The character frame data includes a plurality of point data. Calligraphy control point data is generated using the character frame data. The calligraphy control point data is used to generate a calligraphed writing image. The calligraphed writing message including the calligraphy control point data is generated. The calligraphed writing message is transmitted to a receiving apparatus.

In accordance with another aspect of the present invention, a method is provided for receiving a calligraphed writing message in a receiving apparatus. A calligraphed writing message including calligraphy control point data is received from a transmitting apparatus. A calligraphy outline is generated using the calligraphy control point data. A calligraphed writing image is generated by performing graphic processing on the calligraphy outline. The calligraphed writing image is displayed.

In accordance with another aspect of the present invention, a system is provided for transmitting and receiving a calligraphed writing message. The system includes a transmitting apparatus having an input for receiving writing data, a sampling unit for sampling the writing data to generate character frame data having a plurality of point data, a calligraphy unit for generating calligraphy control point data using the character frame data, and a controller for generating the calligraphed writing message including the calligraphy control point data, and for transmitting the calligraphed writing message to a receiving apparatus. The system also includes the receiving apparatus including a calligraphy unit for generating a calligraphy outline for generation of a calligraphed writing image using the calligraphy control point data from the calligraphed writing message, a graphic processor for performing graphic processing on the calligraphy outline, and a controller for generating and displaying the calligraphed writing image.

In accordance with another aspect of the present invention, an article of manufacture is provided for transmitting a calligraphed writing message. The article of manufacture includes a machine readable medium containing one or more programs which when executed implement the steps of: sampling writing data to generate character frame data, when the writing data is input, wherein the character frame data includes a plurality of point data; generating calligraphy control point data using the character frame data, wherein the calligraphy control point data is used to generate a calligraphed writing image; generating the calligraphed writing message including the calligraphy control point data; and transmitting the calligraphed writing message to a receiving apparatus.

In accordance with another aspect of the present invention, an article of manufacture is provided for receiving a calligraphed writing message. The article of manufacture includes a machine readable medium containing one or more programs which when executed implement the steps of: receiving a calligraphed writing message including calligraphy control point data from a transmitting apparatus; generating a calligraphy outline using the calligraphy control point data; generating a calligraphed writing image by performing graphic processing on the calligraphy outline; and displaying the calligraphed writing image.

### BRIEF DESCRIPTION OF THE DRAWINGS

The above and other aspects, features, and advantages of the present invention will be more apparent from the following detailed description when taken in conjunction with the accompanying drawings, in which:

FIG. 1 is a block diagram illustrating an apparatus for transmitting a message, according to an embodiment of the present invention;

FIG. 2 is a block diagram illustrating an apparatus for receiving a message, according to an embodiment of the present invention;

FIG. 3 is a flowchart illustrating a process for transmitting and receiving a calligraphed writing message between apparatuses for transmitting and receiving a message, according to an embodiment of the present invention;

FIG. 4 is a flowchart illustrating a process for transmitting a calligraphed writing message from an apparatus for transmitting a message to an apparatus for receiving a message, according to an embodiment of the present invention;

FIGS. 5 to 7 illustrate a process for generating a calligraphed writing image, according to an embodiment of the present invention;

FIG. 8 is a flowchart illustrating a process for generating a calligraphed writing image in accordance with a size of an input writing region, according to an embodiment of the present invention;

FIG. 9 is a flowchart illustrating a process for transmitting a calligraphed writing message, which is generated from input text, from a transmitting apparatus to a receiving apparatus, according to an embodiment of the present invention;

FIG. 10 is illustrates a calligraphic writing message in accordance with input text data, according to an embodiment of the present invention;

FIG. 11 is a flowchart illustrating a process in which a receiving apparatus receives a calligraphed writing message and displays the calligraphed writing image on a screen, according to an embodiment of the present invention;

FIGS. 12 to 15 illustrate a process for displaying position data of calligraphy control point data such that it corresponds to a size of a writing display region, according to embodiments of the present invention;

FIGS. 16 to 20 illustrate a process for transmitting and receiving a calligraphed writing image through a mobile messenger, according to an embodiment of the present invention;

FIG. 21 is a flowchart illustrating a process of calligraphing the writing of the user in the transmitting apparatus, according to an embodiment of the present invention;

FIGS. 22 to 24 illustrate the process of calligraphing the user's writing, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

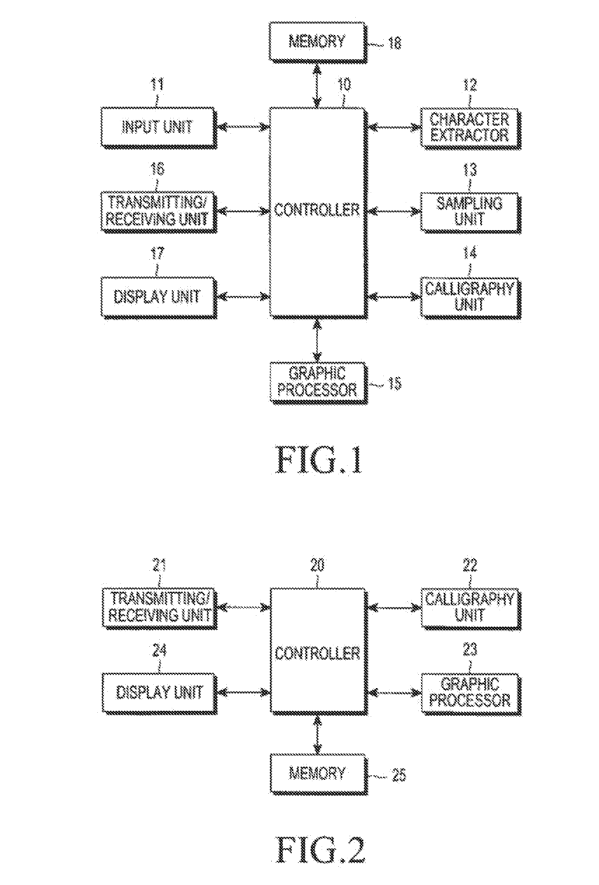

FIG. 1 is a block diagram illustrating an apparatus for transmitting a message, according to an embodiment of the present invention.

According to an embodiment of the present invention, with respect to FIG. 1, writing of a user is input through an input unit 11. The input unit 11 may be embodied as a touch screen.

The apparatus for transmitting a message, according to an embodiment of the present invention, includes a controller 10, the input unit 11, a character extractor 12, a sampling unit 13, a calligraphy unit 14, a graphic processor 15, a transmitting/receiving unit 16, a display unit 17, and a memory 18.

The controller 10 receives an input having user writing that is within a writing input region of the input unit 11, when there is a request for transmitting a calligraphed writing message.

The controller 10 extracts a writing region within the writing input region using the character extractor 12.

The controller 10 samples the extracted writing region using the sampling unit 13, and generates writing frame data that includes a plurality of point data. The writing frame data has various distributions of the point data, which are differently constructed depending on a writing input speed of a user. A low distribution of point data for a writing region corresponds to writing input by the user at a high input speed, while a high distribution of point data for a writing region corresponds to writing input by the user at a low input speed.

The controller 10 generates calligraphy control point data that is used for generating a calligraphically processed writing image based on the writing frame data using the calligraphy unit 14. The calligraphy control point data is used for generating a calligraphy writing outline for calligraphy surrounding the writing frame data.

The controller 10 generates the calligraphy writing outline surrounding the writing frame data using the calligraphy control point data generated using the calligraphy unit 14. The calligraphy unit 14 generates a closed curve surrounding each stroke included in the writing frame data so that the calligraphy writing outline may be generated.

The controller 10 performs graphic processing for the generated calligraphy writing outline using the graphic processor 15, in order to generate a calligraphed writing image.

The controller 10 displays the generated calligraphed writing image through the display unit 17.

The controller 10 generates a calligraphed writing message including calligraphy writing construction information used for generating the calligraphed writing image, and transmits the generated calligraphed writing message to an apparatus for receiving a message through the transmitting/receiving unit 16. The calligraphy writing construction information includes calligraphy control point data and display information. The display information includes position data of the calligraphy control point data and information on a size of a writing input screen of the apparatus for transmitting a message.

According to another embodiment of the present invention, with respect to FIG. 1, text is input through the input unit 11. The input unit 11 may be embodied as a keyboard for inputting the text.

When text is input through the input unit 11, the controller 10 extracts a text region from a text input region using the character extractor 12. The controller 10 identifies a preset writing style to correspond to the extracted text region. In an embodiment of the present invention, the controller 10 receives calligraphy control point data for generating a calligraphed writing image corresponding to a user writing style, sampled from the user's writing, or corresponding to a general writing style. The calligraphy control point data is received in advance from a writing style provider, which provides a plurality of writing styles. The received calligraphed writing image is stored in the memory 18. Accordingly, in an embodiment of the present invention, the user can preset a writing style for calligraphy, and receive offerings corresponding to the preset writing style for calligraphy.

The controller 10 generates a calligraphy writing outline through the calligraphy unit 14 using the calligraphy control point data corresponding to the identified writing style.

The controller 10 performs graphic processing on the generated calligraphy writing outline using the graphic processor 15 to generate a calligraphed writing image.

The controller 10 displays the generated calligraphed writing image through the display unit 17.

The controller 10 generates a calligraphed writing message including calligraphy writing construction information, which is used for generating the calligraphed writing image. The controller 10 transmits the generated calligraphed writing message to the apparatus for receiving a message through the transmitting/receiving unit 16.

The input unit 11 receives an input of writing or text from the user, and outputs data corresponding to the input of the writing or the text to the controller 10. The input unit 11 may include a touch screen for a writing input and/or a keyboard for a text input.

The character extractor 12 extracts the writing region input within the writing input region or the text region input within the text input region.

The sampling unit 13 samples the extracted writing region to generate writing frame data including a plurality of points.

The calligraphy unit 14 generates calligraphy control point data that is used for generating the calligraphed writing image based on the writing frame data. The calligraphy unit 14 also generates the calligraphy writing outline surrounding the writing frame data using the calligraphy control point data.

When text is input to the input unit 11, the calligraphy unit 14 generates the calligraphy writing outline in surrounding the writing frame data using the calligraphy control point data corresponding to the writing style preset for the extracted text region.

The graphic processor 15 performs graphic processing on the generated calligraphy writing outline in order to generate a calligraphed writing image.

The transmitting/receiving unit 16 transmits the calligraphed writing message, generated by the controller 10, to the apparatus for receiving a message.

The display unit 17 displays the generated calligraphed writing image.

The memory 18 stores calligraphy control point data for generating the calligraphed writing image corresponding to a general writing style or a user writing style, which is sampled from user's writing, provided by a writing style provider that provides information on a writing style.

As described above, embodiments of the present invention can calligraph the user's writing to transmit the calligraphed writing to the other party, and transfer the calligraphy writing construction information used for generating the calligraphed writing image, so that the user can quickly and conveniently transmit the calligraphed writing message.

FIG. 2 is a block diagram illustrating an apparatus for receiving a message, according to an embodiment of the present invention.

The apparatus for receiving a message, according to an embodiment of the present invention, includes a controller 20, a transmitting/receiving unit 21, a calligraphy unit 22, a graphic processor 23, a display unit 24, and a memory 25.

The controller 20 extracts calligraphy writing construction information, which is used for generating a calligraphed writing image, from a calligraphed writing message, when the calligraphed writing message is received through the transmitting/receiving unit 21.

The controller 20 generates calligraphy control point data used for generating the calligraphed writing image through the calligraphy unit 22 using the extracted calligraphy writing construction information. The controller 20 generates a calligraphy writing outline using the generated calligraphy control point data. Specifically, the controller 20 generates the calligraphy writing outline using the calligraphy control point data from the calligraphy writing construction information.

The controller 20 performs graphic processing on the generated calligraphy writing outline through the graphic processor 23 in order to generate a calligraphed writing image. The controller 20 displays the generated calligraphed writing image through the display unit 24.

The transmitting/receiving unit 21 receives the calligraphed writing message from the apparatus for transmitting a message.

The calligraphy unit 22 generates calligraphy control point data using calligraphy writing construction information extracted from the calligraphed writing message, and generates a calligraphy writing outline using the generated calligraphy control point data.

The graphic processor 23 performs graphic processing on the generated calligraphy writing outline in order to generate a calligraphed writing image.

The display unit 24 displays the generated calligraphed writing image.

The memory 25 stores received calligraphy writing construction information, a calligraphed writing message including the calligraphy writing construction information, and information on a size of a writing display region of the apparatus for receiving the message.

Embodiments of the present invention calligraph the user's writing to transmit the calligraphed writing to the other party, and transfer the calligraphy writing construction information used for generating the calligraphed writing image so that the user can quickly and conveniently receive the calligraphed writing message to display the received message on a screen.

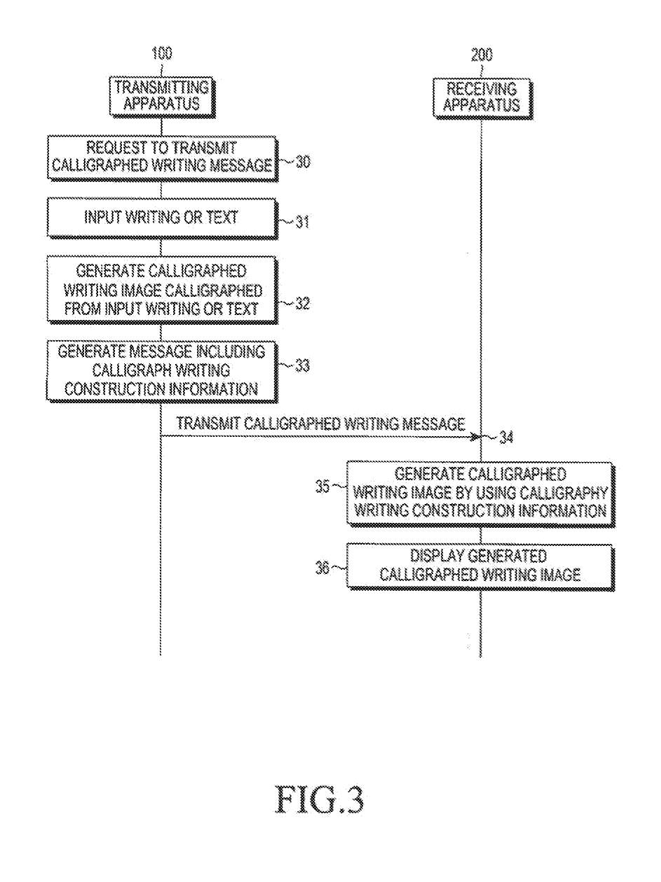

FIG. 3 is a flowchart illustrating a process for transmitting and receiving a calligraphed writing message between apparatuses for transmitting and receiving a message, according to an embodiment of the present invention.

A request for transmitting a calligraphed writing message is received at a transmitting apparatus 100, in step 30. The transmitting apparatus 100 receives an input of a writing or a text, in step 31. The transmitting apparatus generates a calligraphed writing image by calligraphically processing the input of the writing or the text, in step 32.

The transmitting apparatus 100 generates a calligraphed writing message that includes calligraphed writing instruction information, in step 33. The transmitting apparatus 100 transmits the generated calligraphed writing message to a receiving apparatus 200, in step 34.

The receiving apparatus 200 generates a calligraphed writing image using the calligraphed writing instruction information, in step 35. The receiving apparatus 200 displays the generated calligraphed writing image on a screen, in step 36.

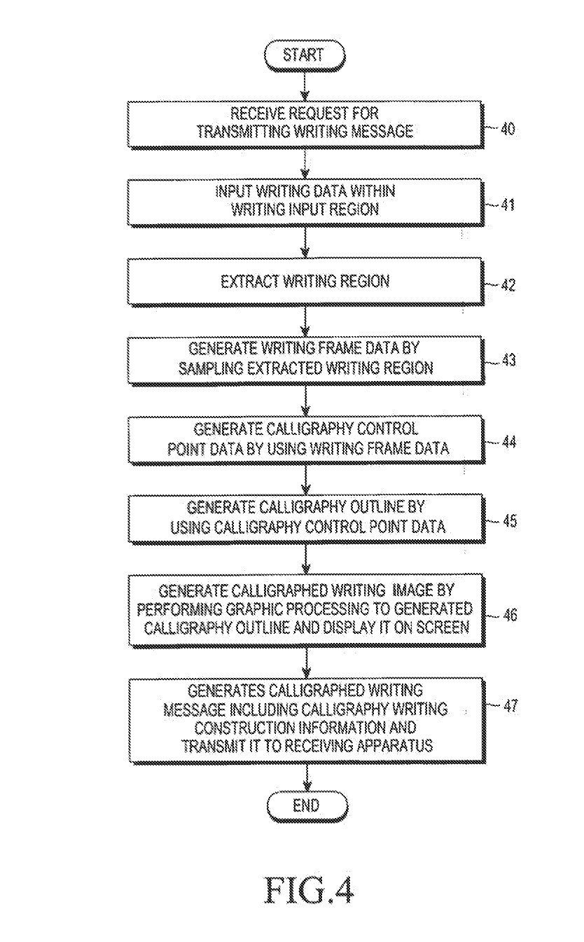

The process of FIG. 3 is described in greater detail below, with reference to FIGS. 4 to 9.

First, a process, in which the transmitting apparatus 100 generates a calligraphed writing message and transmits the generated calligraphed writing message to the receiving apparatus 200, is described with reference to FIGS. 4 to 7.

FIG. 4 is a flowchart illustrating a process for transmitting a calligraphed writing message from the transmitting apparatus to the receiving apparatus, according to an embodiment of the present invention.

A request for transmitting a writing message is received, in step 40. The controller 10 receives an input of writing data within a writing input region from the input unit 11, in step 41, when an input of writing is received at the input unit 11.

The controller 10 extracts a writing region within the writing input region using the character extractor 12, in step 42.

The controller 10 samples the extracted writing region using the sampling unit 13 in order to generate writing frame data, which includes a plurality of point data, in step 43.

The controller 10 generates calligraphy control point data using the writing frame data, in step 44.

The controller 10 generates a calligraphy outline through the calligraphy unit 14 using the calligraphy control point data, in step 45.

The controller 10 performs graphic processing on the generated calligraphy outline through the graphic processor 15 in order to generate a calligraphed writing image and display the generated calligraphed writing image through the display unit 17, in step 46.

The controller 10 generates a calligraphed writing message having calligraphy writing construction information, which includes calligraphy control point data and display information, and transmits the generated calligraphed writing message to the receiving apparatus 200 through the transmitting/receiving unit 18, in step 47.

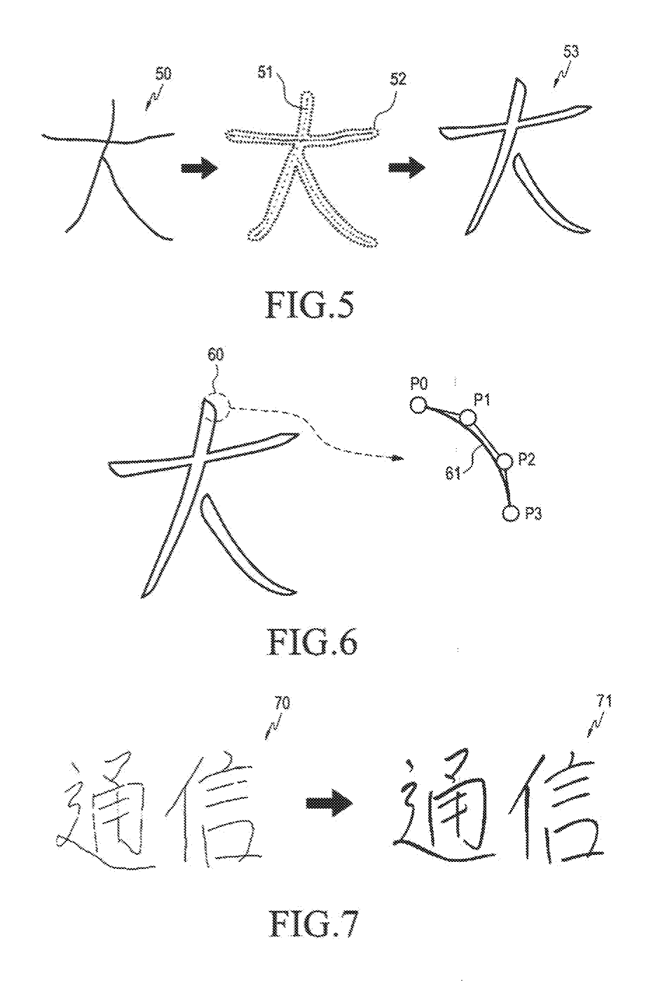

A process in which the controller 10 generates the calligraphed writing image is further described below, with reference to FIGS. 5 to 7.

FIGS. 5 to 7 illustrate a process for generating the calligraphed writing image, according to an embodiment of the present invention.

Referring to FIG. 5, when a writing 50 is input within a writing input region through the input unit 11, the controller 10 extracts an input writing region, and samples the extracted writing region to generate writing frame data 51. The writing frame data 51 includes a plurality of point data. The writing frame data 51 has various distributions of the point data, corresponding to respective strokes, according to a writing input speed of a user.

The controller 10 generates calligraphy control point data 52 used for generating a calligraphy writing outline surrounding the writing frame data 51. The controller 10 generates the calligraphy writing outline using the generated calligraphy control point data, which will be described in detail with reference to FIG. 6.

Referring to FIG. 6, when calligraphy control point data, such as P0, P1, P2, and P3, is generated to form a calligraphy writing outline 60, the controller 10 connects P0 and P3 using the calligraphy unit 14, and generates a closed curve 61 such that a curve connecting P0 and P3 is adjacent to P1 and P2. The closed curve 61 may be embodied as a Bezier curve. A calligraphy writing outline 53 including such closed curves is generated as shown in FIG. 5.

Specifically, the present invention can convert writing data 70 of FIG. 7 into calligraphed writing data 71 of FIG. 7 through the calligraphy processes.

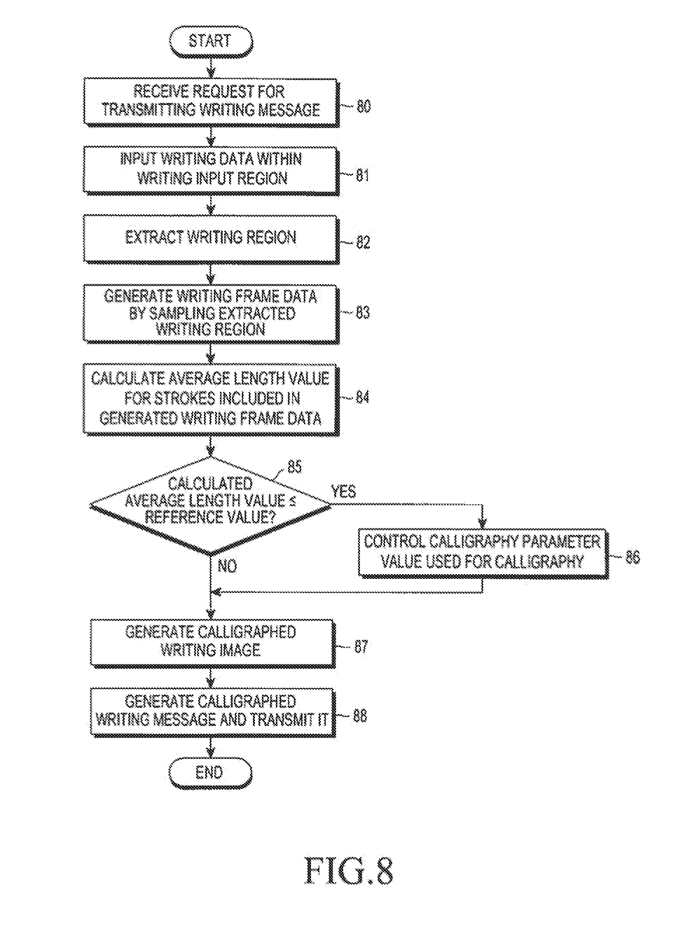

FIG. 8 is a flowchart illustrating a process for generating a calligraphed writing image in accordance with a size of an input writing region, according to an embodiment of the present invention.

Referring to FIG. 8, a request for transmitting a writing message is received, in step 80. The controller 10 receives an input of writing data within a writing input region, in step 81, and extracts a writing region within the writing input region, in step 82.

The controller 10 samples the extracted writing region to generate writing frame data, in step 83.

The controller 10 calculates an average value of lengths of respective writing strokes of the generated writing frame data, in step 84. For example, when the writing frame data includes three writing strokes, the controller 10 calculates an average value of lengths of the three strokes.

The controller 10 determines whether the calculated average value of lengths of strokes is less than or equal to a preset reference value, in step 85. When the calculated average value of the lengths of the strokes is less than or equal to the preset reference value, the controller 10 controls a calligraphy parameter value used for generating a calligraphed writing image, in step 86. The calligraphy parameter value may be a distance value between calligraphy control point data, and a length value of a width of a calligraphy outline generated through the calligraphy control point data. Specifically, when a size of an input writing region is small, the calligraphy parameter value is small in proportion to a size of a writing region, so that a calligraphed writing image corresponding to the size of the corresponding writing region may be generated. The controller 10 then generates a calligraphed writing image, in step 87.

When the calculated average value of the lengths of the strokes is greater than the preset reference value in step 85, the controller 10 generates the calligraphed writing image, in step 87. The controller 10 displays the calligraphed writing image on a screen, generates a calligraphed writing message, and transmits the generated calligraphed writing message to the receiving apparatus 200, in step 88.

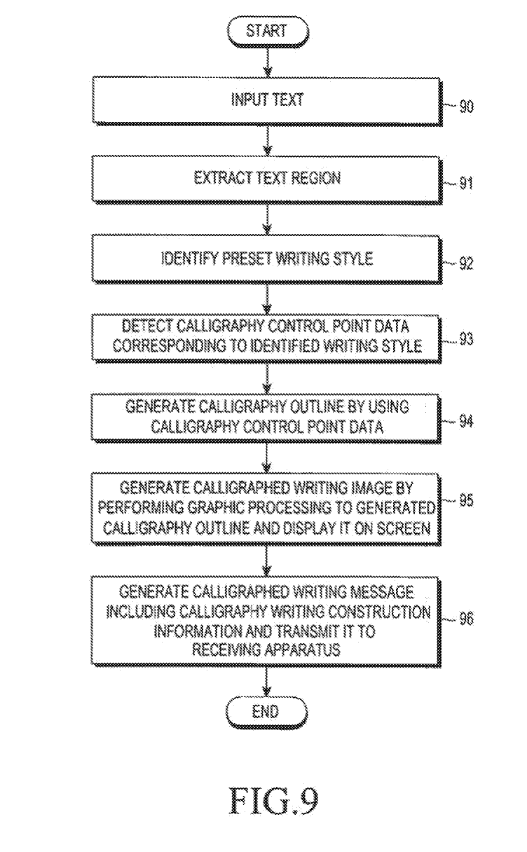

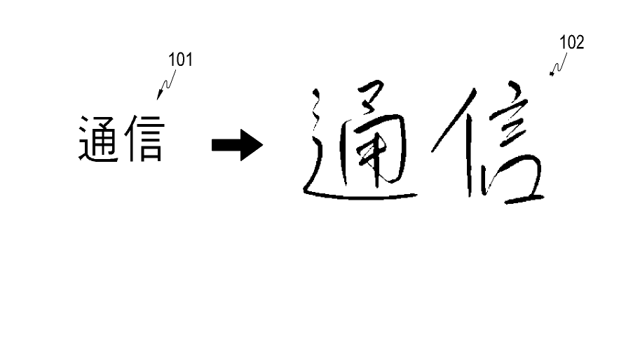

A process in which the transmitting apparatus 100 generates a calligraphed writing message from input text, and transmits the generated calligraphed writing message to the receiving apparatus, is described in detail below with reference to FIGS. 9 and 10.

FIG. 9 is a flowchart illustrating a process for transmitting a calligraphed writing message, which is generated from input text, from the transmitting apparatus to the receiving apparatus, according to an embodiment of the present invention.

A text is input within a text input region, in step 90. The controller 10 extracts a text region within the text input region, in step 91.

The controller 10 identifies a preset writing style in order to generate a calligraphed writing image that corresponds to the extracted text region, in step 92. According to an embodiment of the present invention, the controller 10 receives calligraphy control point data for generating a calligraphed writing image corresponding to a general writing style or a user writing style, which is sampled from a user's writing. The general writing style or the user's writing style is provided in advance from a writing style provider that provides a plurality of writing styles. The controller 10 stores the received calligraphy control point data in the memory 18. Specifically, the controller 10 identifies the writing style pre-stored in the memory 18.

The controller 10 detects calligraphy control point data corresponding to the identified writing style, in step 93, and generates a calligraphy writing outline using the detected calligraphy control point data, in step 94.

The controller 10 performs graphic processing on the generated calligraphy writing outline in order to generate a calligraphed writing image, and then displays the generated calligraphed writing image on a screen, in step 95.

FIG. 10 illustrates a calligraphed writing message in accordance with input text data, according to an embodiment of the present invention.

When text data 101 is input through the input unit 11, the controller 10 performs the calligraphy processes and generates a calligraphed writing image 102.

Referring again to FIG. 9, the controller 10 generates a calligraphed writing message including calligraphy writing construction information, which is used for generating a calligraphed writing image, and transmits the generated calligraphed writing message to the receiving apparatus 200, in step 96.

As described above, embodiments of the present invention can calligraph the user's writing to transmit the calligraphed writing to the other party, by transferring the calligraphy writing construction information used for generating the calligraphed writing image, which enables the user to quickly and conveniently transmit the calligraphed writing message.

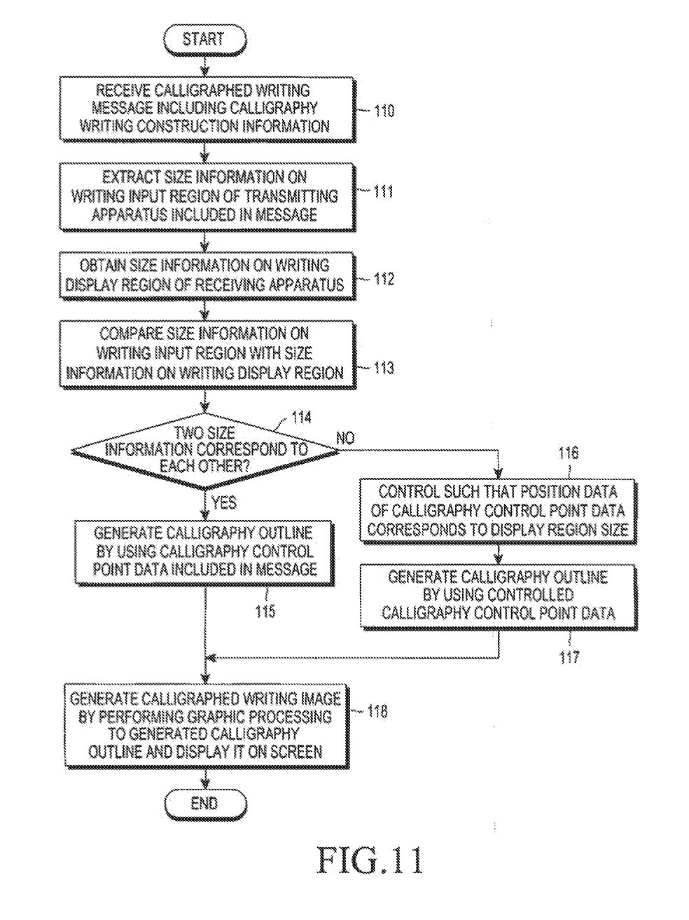

FIG. 11 is a flowchart illustrating a process in which the receiving apparatus receives a calligraphed writing message and displays a calligraphed writing image on a screen, according to an embodiment of the present invention.

Calligraphy writing construction information used for generating a calligraphed writing image is received through the transmitting/receiving unit 21, in step 110. The controller 20 extracts display information among the calligraphy writing construction information included in a calligraphed writing message, in step 111. The calligraphy writing construction information contains the calligraphy control point data and the display information, and contains position data of the calligraphy control point data and size information on the writing input region of the transmitting apparatus.

The controller 20 obtains size information of a writing display region of the receiving apparatus 200, in step 112.

The controller 20 compares the extracted size information of the writing input region with the obtained size information of the writing display region, in step 113.

The controller 20 determines whether the size of the writing input region is identical to the size of the writing display region, in step 114. When the sizes are identical, the controller 20 generates a calligraphy writing outline using the calligraphy control point data of the calligraphy writing construction information included in the calligraphed writing message, through the calligraphy unit 22, in step 115.

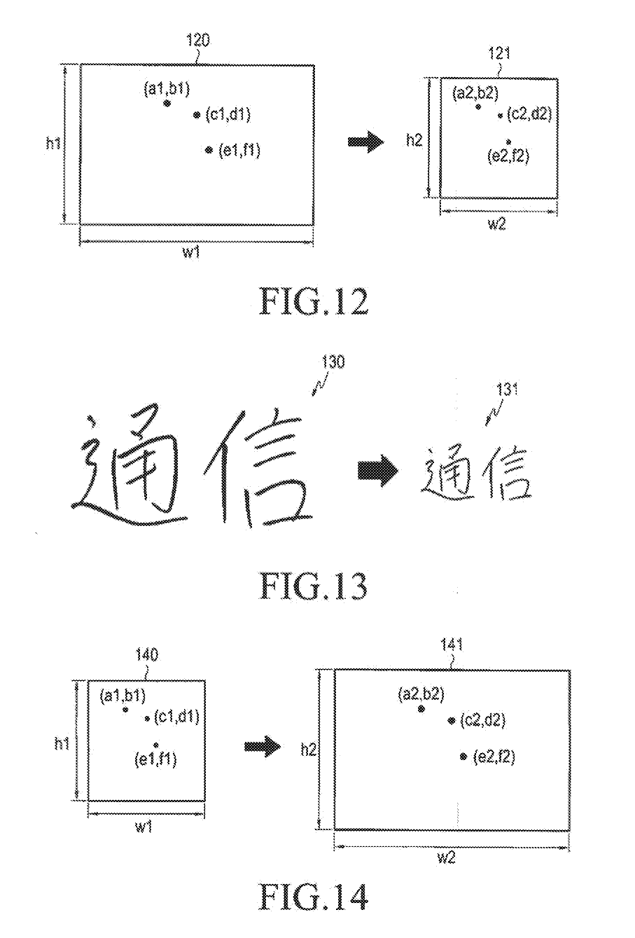

When the size of the writing input region is not identical to the size of the writing display region, the controller 20 displays the position data of calligraphy control point data such that it corresponds to the size of the writing display region, in step 116. Step 116 is described in greater detail below, with reference to FIGS. 12 to 15.

FIGS. 12 to 15 illustrate a process for displaying the position data of the calligraphy control point data such that it corresponds to the size of the writing display region, according to an embodiment of the present invention.

Referring to FIG. 12, the controller 20 compares two sizes based on an assumption that a size of a writing input region 120 of the transmitting apparatus 100 has a width w1 and a height h1, and a writing display region 121 of the receiving apparatus 200 has a width w2 and a height h2. The controller 20 regulates control point data located in (a1, b1), (c1, d1), and (e1, f1) to (a2, b2), (c2, d2), and (e2, f2), respectively. The regulated control point data of (a2, b2), (c2, d2), and (e2, f2) has values of a2=a1×h2/h1, b2=b1×h2/h1, c2=c1×h2/h1, d2=d1×h2/h1, e2=e1×h2/h1, and f2=f1×h2/h1.

Accordingly, writing data input in the transmitting apparatus 100 shown in FIG. 13 is generated as a calligraphed writing image 130 in FIG. 13, regulated as a smaller calligraphed writing image 131 to correspond to the size of the writing display region, and displayed on a screen.

Referring to FIG. 14, the controller 20 compares two sizes based on an assumption that a size of a writing input region 140 of the transmitting apparatus 100 has a width w1 and a height h1, and a writing display region 141 of the receiving apparatus 200 has a width w2 and a height h2. The controller 20 regulates control point data located in (a1, b1), (c1, d1), and (e1, f1) to (a2, b2), (c2, d2), and (e2, f2), respectively. The regulated control point data of (a2, b2), (c2, d2), and (e2, f2) has values of a2=a1×h2/h1, b2=b1×h2/h1, c2=c1×h2/h1, d2=d1×h2/h1, e2=e1×h2/h1, and f2=f1×h2/h1.

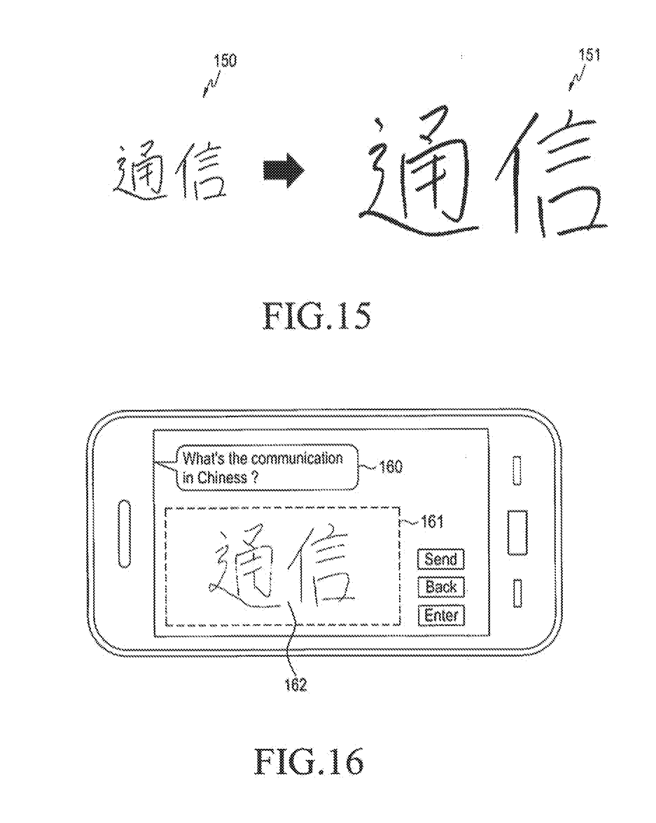

Accordingly, writing data input in the transmitting apparatus 100 shown in FIG. 13 is generated as a calligraphed writing image 150 in FIG. 15, regulated as a larger calligraphed writing image 151 to correspond to the size of the writing display region, and displayed on a screen.

Referring again to FIG. 11, the controller 20 generates a calligraphy outline through the calligraphy unit 22 using the regulated calligraphy control point data, in step 117.

The controller 20 performs graphic processing on the generated calligraphy writing outline through the graphic processor 23, generates a calligraphed writing image, and then displays the generated calligraphed writing image through the display unit 24, in step 118.

A process of transmitting and receiving a message between a transmitter and a receiver using a mobile messenger for the calligraphy processes is described in detail with reference FIGS. 16 to 20.

FIGS. 16 to 20 illustrate a process of transmitting and receiving a calligraphed writing image through a mobile messenger, according to an embodiment of the present invention.

In FIG. 16, the transmitting apparatus 100 receives an input of writing data 162 in a writing input region 161 in response to reception of another party's message 160.

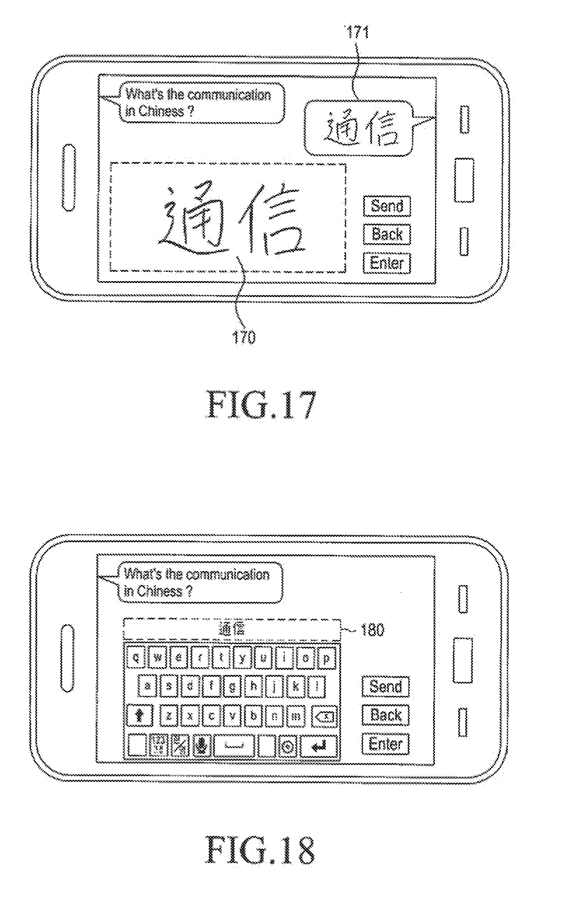

In FIG. 17, the transmitting apparatus 100 performs the calligraphy processes to the input writing data to generate calligraphed writing data 170, and displays the generated writing data 170 in the writing input region 161 and a message display screen 171. The transmitting apparatus 100 transmits a calligraphed writing message including calligraphy construction information used for generating the calligraphed writing data 170 to the receiving apparatus 200.

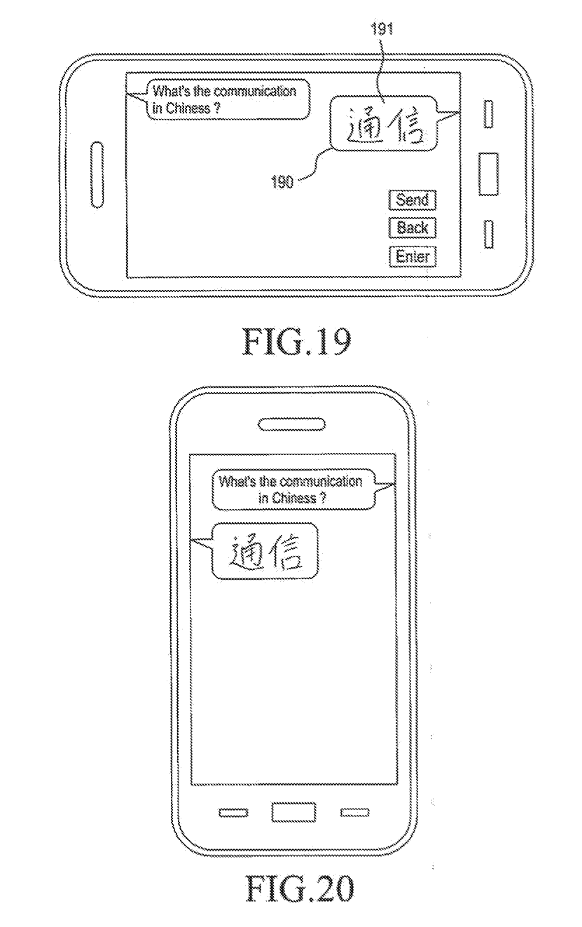

The transmitting apparatus 100 can receive an input of text data in a text input region 180 through a keyboard, as shown in FIG. 18. When the text data is input, the transmitting apparatus 100 identifies a preset writing style to correspond to the text data, and generates calligraphed writing data corresponding to the identified preset writing style. Subsequently, the transmitting apparatus 100 displays the generated calligraphed writing data 191 on a message display screen 190, as shown in FIG. 19.

The receiving apparatus 200 receives a calligraphed writing message including calligraphy writing construction information, generates the calligraphed writing image using the calligraphy writing construction information, and displays the generated calligraphed writing image in a message display region, as shown in FIG. 20.

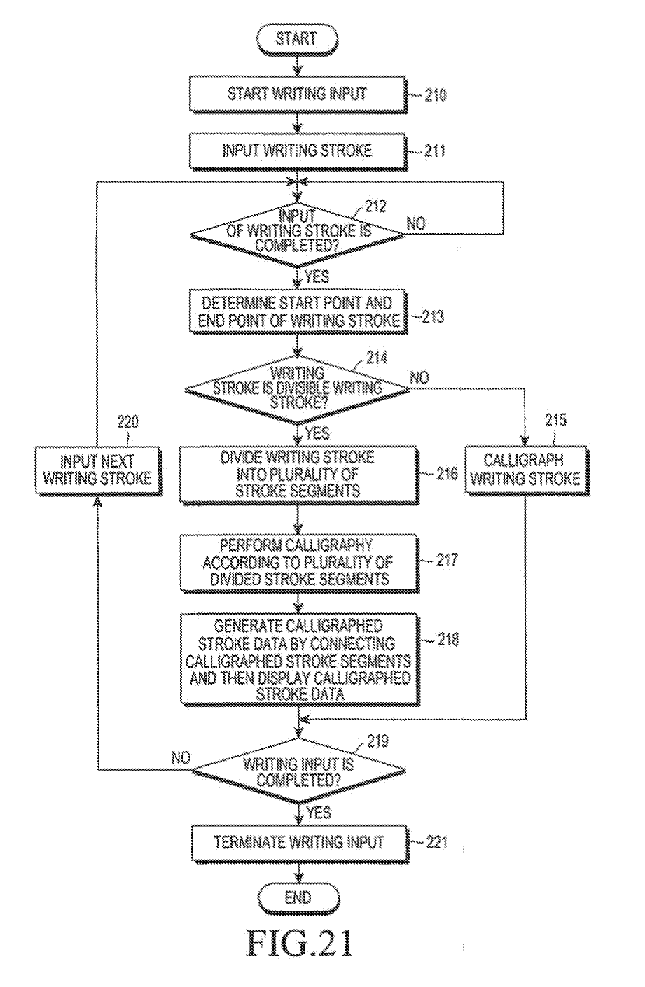

FIG. 21 is a flowchart illustrating a process of calligraphing the writing of the user in the transmitting apparatus, according to an embodiment of the present invention.

Referring to FIG. 21, a writing input of the user is started, in step 210. The controller 10 receives an input of a writing stroke, in step 211.

The controller 10 determines whether the input of the writing stroke is completed, in step 212. When the input of the writing stroke is completed, the controller 10 proceeds to step 213. Otherwise, the controller 10 continuously determines whether the input of the writing stroke is completed, in step 212. Specifically, the controller 10 determines whether an end point of the writing stroke is detected in order to determine whether the input of the writing stroke is completed. When the end point of the writing stroke is detected, the controller 10 determines that the input of the writing stroke is completed.

The controller 10 determines a start point and the end point of the input writing stroke, in step 213. The controller 10 recognizes a position where a press down event is started within an area of the writing input of the input unit 11 as the start point of the writing stroke. The controller 10 recognizes a position where a release event is started as the end point of the writing stroke. The position where the press down event is started is a position where the user comes into contact, through his/her finger, with the area of the writing input. The position where the release event is started means a position where the contact by the finger of the user is separated from the area of the writing input. A pointing device, other than the user's finger, may also be used.

The controller 10 determines whether the input writing stroke is a divisible writing stroke, in step 214. When the input writing stroke is a divisible writing stroke, the controller 10 proceeds to step 216. When the input writing stroke is not a divisible writing stroke, the controller 10 performs calligraphy for the input writing stroke, in step 215. A method of performing the calligraphy in step 215 is the same as the method described above. The controller 10 determines a length of the writing stroke using the start point and the end point of the determined writing stroke, and then determines whether the determined length of the writing stroke is a length of the divisible writing stroke. For example, the controller 10 presets a reference length of the divisible writing stroke, and performs the calligraphy for the writing stroke when the determined length of the writing stroke is less than the preset reference length of the writing stroke. The controller 10 recognizes a writing trajectory between the start point and the end point of the writing stroke, and determines a length of the recognized writing trajectory as the length of the writing stroke.

When it is determined that the input writing stroke is a divisible writing stroke, the controller 10 divides the input writing stroke into a plurality of segments, in step 216. Specifically, the controller 10 divides the writing stroke between the start point and the end point into a plurality of segments according to a preset division reference. The preset division reference may be a degree of a curve of the stroke, or an input time of the writing stroke.

The controller 10 performs the calligraphy according to each of the plurality of divided stroke segments, in step 217. The controller 10 performs the calligraphy for each divided stroke segment, and generates a plurality of calligraphed stroke segments. Specifically, the controller 10 generates the plurality of stroke segments as a plurality of writing frame data including several point data. The controller 10 generates calligraphy control point data used to generate the calligraphed writing image based on the writing frame data through the calligraphy unit 14. The controller 10 generates a calligraphed writing outline surrounding the writing frame data by using the calligraphy control point data generated through the calligraphy unit 14. The calligraphy unit 14 can generate the calligraphed writing outline by generating a closed curve surrounding respective strokes configuring the writing frame data. The controller 10 generates calligraphed stroke segments by performing graphic processing on the generated calligraphed writing outline through the graphic processor 15. Further, the controller 10 identifies a preset writing style in order to generate the calligraphed writing image, generates the calligraphed writing outline through the calligraphy unit 14 by using the calligraphy control point data corresponding to the identified writing style, and then generates the calligraphed stroke segments by performing the graphic processing through the graphic processor 15. In an embodiment of the present invention, the calligraphy control point data for generating the calligraphed writing image corresponding to a user writing style, sampled from the user's writing, or a general writing style is received in advance from a writing style provider for providing a plurality of writing styles, and then stored in the memory unit 18. Specifically, the user presets the writing style for the calligraphy, receives the calligraphy control point data corresponding to the preset writing style for the calligraphy, and generates the calligraphed stroke segments.

The controller 10 generates the calligraphed stroke data by connecting the plurality of calligraphed stroke segments, and then displays the generated calligraphed stroke data through the display unit 17, in step 218. The controller 10 smoothly connects the divided stroke segments by performing the calligraphy in an area of adjacent segments of the calligraphed stroke segments when connecting the plurality of calligraphed stroke segments.

The controller 10 determines whether the writing input is completed in step 219. When the writing input is completed, the controller 10 terminates the writing input in step 221. When the writing input is not completed, the controller 10 receives an input of a next stroke in step 220, and then returns to steps 212 to 219.

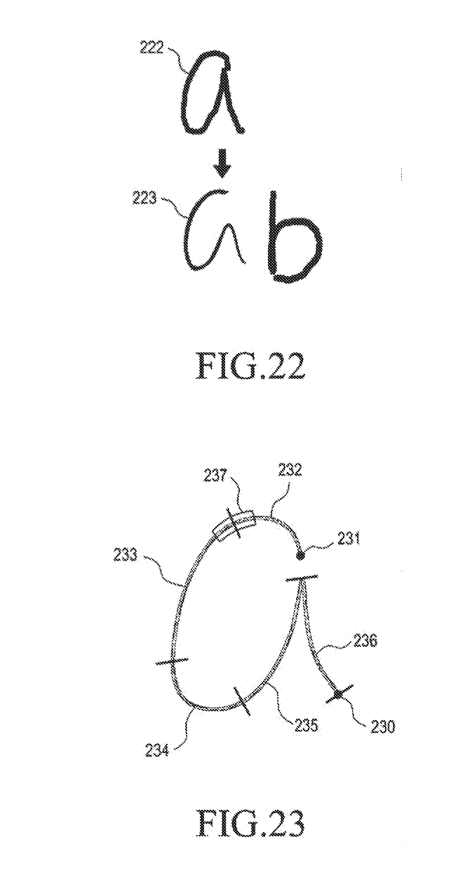

FIGS. 22 to 24 illustrate the process of calligraphing the user's writing, according to an embodiment of the present invention.

FIG. 22 illustrates a process of calligraphing and displaying the input writing stroke before a next writing stroke is input, according to an embodiment of the present invention.

Referring to FIG. 22, when a writing input of the user is started, the controller 10 receives an input of a writing stroke 222, and determines whether the input of the writing stroke 222 is completed. When the input of the writing stroke is completed, the controller 10 performs the calligraphy for the corresponding writing stroke. The controller 10 performs the calligraphy using a start point and an end point of the writing stroke 222, and then generates calligraphed stroke data 223, which will be described in detail with reference to FIG. 23.

FIG. 23 illustrates a process of diving and calligraphing the writing stroke, according to an embodiment of the present invention.

According to FIG. 23, the controller 10 detects a start point 231 and an end point 230 of the writing stroke, detects a size of the writing stroke using the detected start point and the end point 230, and then determines whether the detected size of the writing stroke is a divisible size.

When the size of the writing stroke is the divisible size, the controller 10 divides the writing stroke into five stroke segments 232, 233, 234, 235, and 236, according to a preset division reference. The controller 10 performs the calligraphy according to the divided five stroke segments, and again performs the calligraphy to smoothly connect an adjacent area 237. The adjacent area 237 between stroke segments 232 and 233, an adjacent area between stroke segments 233 and 234, an adjacent area between stroke segments 234 and 235, and an adjacent area between stroke segments 235 and 236 are equally calligraphed.

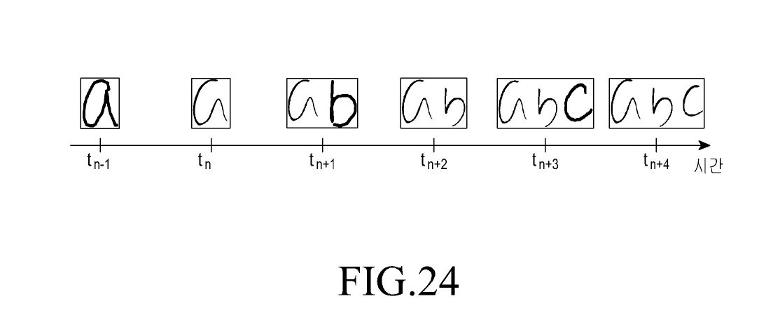

When the calligraphy for the input writing stroke is completed, the controller 10 determines whether the writing input is completed, and receives an input of a next writing stroke when the writing input is not completed. Thus, the calligraphy for the input writing stroke may be performed in chronological order in an embodiment of the present invention, which will be described in greater detail below with reference to FIG. 24.

FIG. 24 illustrates a process of calligraphing input writing strokes in chronological order and displaying the calligraphed writing strokes, according to an embodiment of the present invention.

Referring to FIG. 24, when a writing “a” is input at a tn−1 time, the controller 10 calligraphs the writing “a” at a to time and then displays the calligraphed writing “a”. When a writing “b” is input at the tn+1 time, the controller 10 calligraphs the writing “b” at a tn+2 time and then displays the calligraphed writing “b”. When a writing “c” is input at the tn+3 time, the controller 10 calligraphs the writing “c” at a tn+4 time and then displays the calligraphed writing c. Accordingly, in an embodiment of the present invention, a method of performing the calligraphy as the writing stroke is completed may be used, as well as a method of calligraphing the writing of which the input is completed after the writing input of the user is completed.

As described above, embodiments of the present invention can calligraph the user's writing to transmit the calligraphed writing to another party, by transferring the calligraphy writing construction information used for generating the calligraphed writing image so that the user can quickly and conveniently transmit the calligraphed writing message.

The embodiments of the present invention are advantageous in that users can more intuitively and conveniently use a mobile message service in a smart phone, and efficiently receive a written message so that it is possible to generate a new message service.

Software components including instructions or code for performing the methodologies described herein may be stored in one or more of the associated memory devices (i.e., the memories 18 and 25) and, when ready to be utilized, loaded in part or in whole (e.g., into Random Access Memory (RAM)) and executed by the controllers 10 and 20.

While the invention has been shown and described with reference to certain embodiments thereof, it will be understood by those skilled in the art that various changes in form and detail may be made therein without departing from the spirit and scope of the invention as defined by the appended claims.

What is claimed is:

1. An apparatus for transmitting a calligraphed writing message, the apparatus comprising:
an input unit for receiving writing data;
a sampling unit for sampling the writing data to generate character frame data, wherein the character frame data comprises a plurality of point data;
a calligraphy unit for generating calligraphy control point data using the character frame data, wherein the calligraphy control point data is used to generate a calligraphed writing image; and
a controller for controlling the sampling unit to generate the character frame data when the writing data is received through the input unit, for controlling the calligraphy unit to generate the calligraphy control point data using the character frame data, for generating the calligraphed writing message comprising the calligraphy control point data, and for transmitting the calligraphed writing message to a receiving apparatus.

2. The apparatus as claimed in claim 1, further comprising a graphic processor for performing graphic processing, wherein the calligraphy unit generates a calligraphy outline surrounding the character frame data using the calligraphy control point data, and wherein the controller controls the graphic processor to perform the graphic processing on the calligraphy outline, generates the calligraphed writing image, and displays the calligraphed writing image on a screen.

3. The apparatus as claimed in claim 2, wherein the controller calculates an average value of lengths of stroke data included in the character frame data, determines whether the average value is less than or equal to a preset reference value, controls a ratio of the calligraphy outline to correspond to a size of the character frame data when the average value is less than or equal to the preset reference value, and controls the calligraphy unit to generate the calligraphy outline in accordance with the ratio.

4. The apparatus as claimed in claim 3, wherein the calligraphed writing message further comprises display information having position data of the calligraphy control point data and size information of a writing input region of the apparatus.

5. The apparatus as claimed in claim 1, wherein the input unit is for receiving text data, and wherein, when the text data is received at the input unit, the controller identifies a preset writing style in order to generate the calligraphed writing image corresponding to the text data, and detects the calligraphy control point data corresponding to the preset writing style.

6. The apparatus as claimed in claim 1, wherein, when the writing data is received at the input unit, the controller determines whether an input of a writing stroke of the writing data is completed, and, when the input of the writing stroke is completed, the controller performs calligraphy for the writing stroke, generates calligraphed writing stroke data, displays the calligraphed writing stroke data on a screen, and receives an input of a next writing stroke of the writing data through the input unit.

7. The apparatus as claimed in claim 6, wherein the controller divides the writing stroke into a plurality of stroke segments, performs the calligraphy according to the plurality of stroke segments, connects the plurality of calligraphed stroke segments, and generates the calligraphed writing stroke data.

8. An apparatus for receiving a calligraphed writing message, the apparatus comprising:
a calligraphy unit for generating a calligraphy outline for generation of a calligraphed writing image;
a graphic processor for performing graphic processing; and
a controller for controlling the calligraphy unit to generate the calligraphy outline using calligraphy control point data when the calligraphed writing message comprising the calligraphy control point data is received from a transmitting apparatus, controlling the graphic processor to perform the graphic processing on the calligraphy outline, generating the calligraphed writing image, and displaying the calligraphed writing image.

9. The apparatus as claimed in claim 8, wherein the calligraphed writing message further comprises display information having position data of the calligraphy control point data and size information of a writing input region of the transmitting apparatus.

10. The apparatus as claimed in claim 9, wherein the controller obtains size information of a writing display region of the apparatus, compares the size information of the writing input region and the size information of the writing display region, and controls the position data of the calligraphy control point data to fit a size of the writing display region when the size information of the writing input region and the size information of the writing display region are not identical.

11. A method of transmitting a calligraphed writing message in a transmitting apparatus, the method comprising the steps of:
sampling writing data to generate character frame data, when the writing data is input, wherein the character frame data comprises a plurality of point data;
generating calligraphy control point data using the character frame data, wherein the calligraphy control point data is used to generate a calligraphed writing image;
generating the calligraphed writing message comprising the calligraphy control point data; and
transmitting the calligraphed writing message to a receiving apparatus.

12. The method as claimed in claim 11, further comprising:
generating a calligraphy outline surrounding the character frame data using the calligraphy control point data;
generating the calligraphed writing image by performing graphic processing on the calligraphy outline; and
displaying the calligraphed writing image on a screen.

13. The method as claimed in claim 12, further comprising:
calculating an average value of lengths of stroke data included in the character frame data;
determining whether the average value is less than or equal to a preset reference value;
controlling a ratio of the calligraphy outline to correspond to a size of the character frame data when the average value is less than or equal to the preset reference value; and
generating the calligraphy outline in accordance with the ratio.

14. The method as claimed in claim 13, wherein the calligraphed writing message further comprises display information having position data of the calligraphy control point data and size information of a writing input region of the transmitting apparatus.

15. The method as claimed in claim 11, further comprising:
identifying a preset writing style in order to generate the calligraphed writing image corresponding to text data, when the text data is received; and
detecting the calligraphy control point data corresponding to the preset writing style.

16. The method as claimed in claim 11, further comprising:
determining whether an input of a writing stroke of the writing data is completed;
performing calligraphy for the writing stroke and generating calligraphed writing stroke data, when the input of the writing stroke of the writing data is completed;
displaying the calligraphed writing stroke data and receiving an input of a next writing stroke of the writing data.

17. The method as claimed in claim 16, wherein generating the calligraphed writing stroke data comprises:
dividing the writing stroke into a plurality of stroke segments;
performing calligraphy according to the plurality of stroke segments, and connecting the plurality of calligraphed stroke segments to generate the calligraphed writing stroke data.

18. A method of receiving a calligraphed writing message in a receiving apparatus, the method comprising the steps of:
receiving a calligraphed writing message comprising calligraphy control point data from a transmitting apparatus;
generating a calligraphy outline using the calligraphy control point data;
generating a calligraphed writing image by performing graphic processing on the calligraphy outline; and
displaying the calligraphed writing image.

19. The method as claimed in claim 18, wherein the calligraphed writing message further comprises display information having position data of the calligraphy control point data and size information of a writing input region of the transmitting apparatus.

20. The method as claimed in claim 19, further comprising:
obtaining size information of a writing display region of the apparatus;
comparing the size information of the writing input region with the size information of the writing display region; and
controlling the position data of the calligraphy control point data to fit a size of the writing display region, when the size information on the writing input region with the size information on the writing display region are not identical.

21. An article of manufacture for transmitting a calligraphed writing message, comprising a machine readable medium containing one or more programs which when executed implement the steps of:
sampling writing data to generate character frame data, when the writing data is input, wherein the character frame data comprises a plurality of point data;
generating calligraphy control point data using the character frame data, wherein the calligraphy control point data is used to generate a calligraphed writing image;
generating the calligraphed writing message comprising the calligraphy control point data; and
transmitting the calligraphed writing message to a receiving apparatus.

22. An article of manufacture for receiving a calligraphed writing message, comprising a machine readable medium containing one or more programs which when executed implement the steps of:
receiving a calligraphed writing message comprising calligraphy control point data from a transmitting apparatus;
generating a calligraphy outline using the calligraphy control point data;
generating a calligraphed writing image by performing graphic processing on the calligraphy outline; and
displaying the calligraphed writing image.
